(19) United States
(12) Patent Application Publication
(10) Pub. No.: US 2017/0299133 A1
(43) Pub. Date: Oct. 19, 2017

(54) LED LIGHT STRING FOR NON-DIRECTIONAL LIGHTING

(71) Applicant: TIANXI OPTOELECTRONIC TECHNOLOGY CO., LTD., Kaohsiung City (TW)

(72) Inventor: Ying-Fu KUO, Kaohsiung City (TW)

(73) Assignee: TIANXI OPTOELECTRONIC TECHNOLOGY CO., LTD., Kaohsiung City (TW)

(21) Appl. No.: 15/130,295

(22) Filed: Apr. 15, 2016

(51) Int. Cl. F21S 4/26; F21V 15/01

(52) U.S. Cl. CPC F21S 4/26; F21V 15/01

(57) ABSTRACT

A light-emitting diode (LED) light string for non-directional lighting has an LED strip and a transparent protection tube mounted around the LED strip. The LED strip has clear and transparent substrate, multiple conductive wires formed on the transparent substrate, and multiple SMT LEDs attached on the transparent substrate. Each of the SMT LED is a substantially transparent structure with good optical clarity. Therefore, light generated from the LED is emitted toward multiple directions to achieve a non-directional lighting effect.

### BACKGROUND OF THE INVENTION

### 1. Field of the Invention

The present invention relates to a light-emitting diode (LED) light string and, more particularly, to an LED light string for non-directional lighting.

### 2. Description of the Related Art

In recent years, LED-based light strings have become common in many applications to provide decorative and lighting effects. The light strings may be made of flexible material so that the light strings can be attached to different curved surfaces and extended around any objects in irregular shape. With reference to FIG. 13, LEDs 90 used in the light string may be the DIP-packaged (dual in line package) LEDs 90 attached on a flexible substrate 91. The flexible substrate 91 functions as a circuit board for electrically connecting the LEDs 90 and is coated with an opaque insulative layer on a surface thereof. Because the emitted light of the DIP-packaged LEDs 91 is limited to a specific direction, the visual appearance of the light strip is unappealing.

With reference to FIG. 14, the flexible substrate 91 having the LEDs 90 disposed thereon is further sealed in a flexible and insulative tube by injection molding technique. The insulative tube is composed of an inner tube 92 and an outer tube 93. Firstly, the inner tube 92 is formed by a first injection molding process and provided to mount around the flexible substrate 91, wherein two power traces 95 are embedded in the inner tube 92 and electrically connected to the flexible substrate 91 to supply power for driving the LEDs 90. It is noted that the connection of the power traces 95 to the flexible substrate 91 is usually a work of manual labor done by operators. Subsequent to the inner tube 92, the outer tube 93 is formed by a second injection molding process and coated around the inner tube 92. Therefore, the manufacture of the light string is relatively complicated, inefficient and costly.

### SUMMARY OF THE INVENTION

An objective of the present invention is to provide a light-emitting diode (LED) light string that enables light generated from LEDs to illuminate in multiple directions.

To achieve the foregoing objective, the LED light string comprises an LED strip and a transparent and flexible protection tube mounted around the LED strip.

The LED strip includes a transparent and flexible substrate, multiple conductive wires formed on a surface of the transparent substrate, and multiple LEDs mounted on the transparent substrate. The conductive wires include two power buses and multiple separate intermediate wires formed between the power buses.

The type of each LED is the surface-mounted (SMT) LED. Each LED has a transparent base, two leads attached on the top surface of the base and extending along opposite sides the base, a transparent housing mounted on the top surface of the base and forming a cavity, an LED chip mounted in the cavity and electrically connected to the two leads, and a transparent epoxy filler filling the cavity.

Because the transparent substrate is made by clear and transparent material and the LED has a substantially transparent structure, light generated from the LED can be emitted toward multiple directions to enhance visual appearance of the LED light string and achieve a non-directional lighting effect.

Other objectives, advantages and novel features of the invention will become more apparent from the following detailed description when taken in conjunction with the accompanying drawings.

### BRIEF DESCRIPTION OF THE DRAWINGS

FIG. 1 shows an exemplary embodiment of an LED strip in accordance with the present invention;

FIG. 2 shows a transparent substrate in FIG. 1;

FIG. 3 is a circuit diagram of the LED strip in FIG. 1;

FIG. 4 is a schematic cross-sectional view of an LED in FIG. 1;

FIG. 5 is a schematic cross-sectional view of an exemplary embodiment of an LED light string in accordance with the present invention;

FIGS. 6 to 10 are schematic cross-sectional views of different embodiments of the protection tube in accordance with the present invention;

FIG. 11 is a schematic perspective view of an LED light string having ring-shaped decorative shells;

FIG. 12 is a schematic perspective view of an LED light string having ball-shaped shells;

FIG. 13 shows a conventional LED light string; and

FIG. 14 is a cross sectional view of the conventional LED light string.

### DETAILED DESCRIPTION OF THE INVENTION

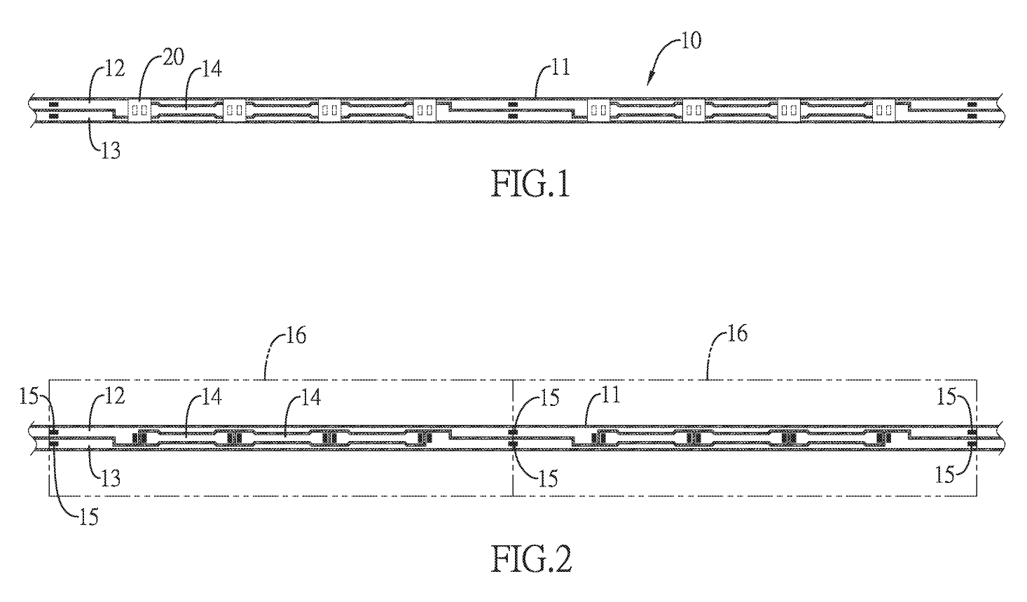

With reference to FIGS. 1 and 2, an exemplary embodiment of a light emitting diode (LED) strip 10 used in an LED light string of the present invention comprises a transparent substrate 11, conductive wires 12-14 formed on the transparent substrate 11, and a plurality of LEDs 20.

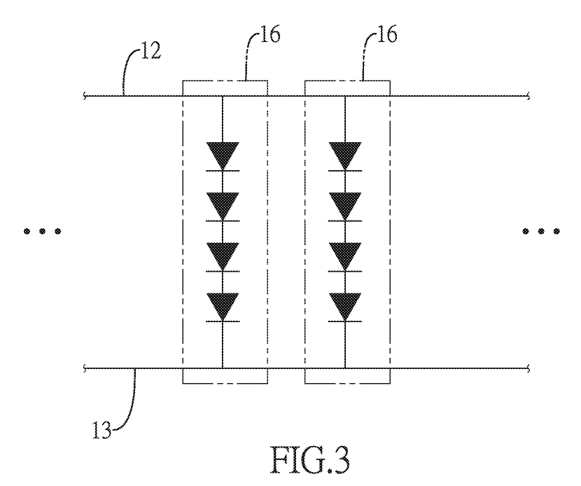

The transparent substrate 11 is fabricated by flexible, clear and transparent material such as polyethylene terephthalate (PET) material in a form of an elongated and narrow strip. The conductive wires 12-14 may be copper or metallic wires formed on at least one surface of the transparent substrate 11. The conductive wires 12-14 include two power buses 12, 13 formed along opposite edges of the transparent substrate 11 respectively, and multiple separate intermediate wires 14 distributed between the power buses 12, 13. Further, multiple segment pads 15 are formed on the power buses 12, 13 to divide the transparent substrate 11 to multiple units 16. With further reference to FIG. 3, the LEDs 20 mounted in the same unit 16 are sequentially mounted on the intermediate wires 14 so that the LEDs 20 are connected in series. The multiple units 16 are connected in parallel between the power buses 12, 13. Therefore, even one of the LEDs 20 fails, the remaining LEDs 20 in other units 16 still operate normally.

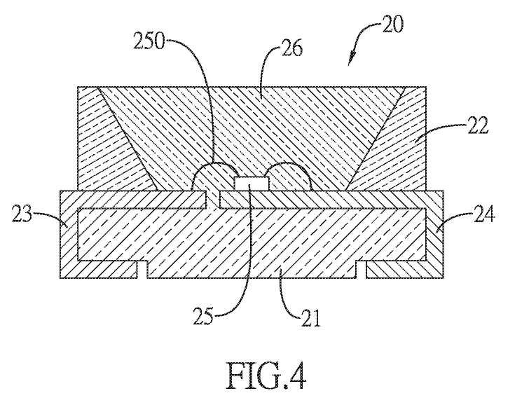

With reference to FIG. 4, each of the plurality of LEDs 20 is fabricated by surface-mount technology (SMT). The LED 20 has a base, 21, a housing 22, two leads 23, 24, an LED chip 25 and an epoxy filler 26. The base 21 is made by clear and transparent material and has a top surface and a bottom surface. The two leads 23, 24, as a cathode and an anode respectively of the LED 20 for connecting to the transparent substrate 11, are attached on the top surface of the base 21 and extend along opposite sides of the base 21. The housing 22 made of transparent material is mounted on the top surface of the base 21 and on the two leads 23, 24. The housing 22 forms a cup-shaped cavity to expose the LED chip 25. The LED chip 25 may be mounted on any one of the two leads 23 and electrically connect to the other lead 24 via a bonding wire 250. The epoxy filler 26 fills the cup-shaped cavity of the housing 22 and has good optical clarity.

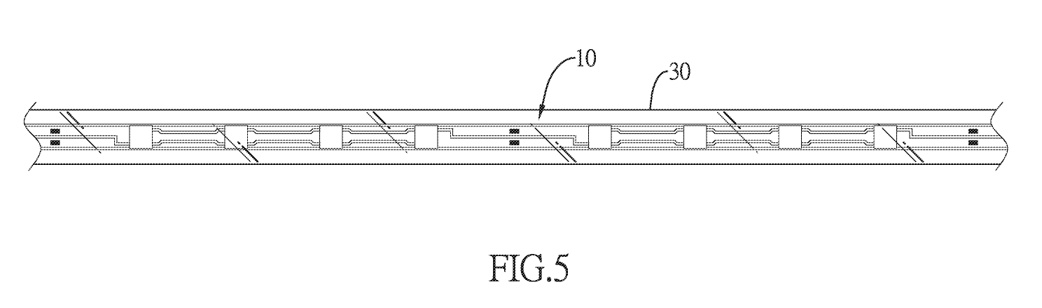

With reference to FIG. 5, the LED strip 10 is further mounted in a protection tube 30. The protection tube 30 is thin and hollow and forms a channel 31 for receiving the LED strip 10. The protection tube 30 may be made of soft, clear and transparent material to enable the LED light string to be arbitrarily rolled around an object. Since the power buses 12, 13 have been provided on the transparent substrate 11, there is no need to embed power wires in the protection tube 30. In other words, the protection tube 30 can be formed as a single layer without adopting two stages of injection molding processes.

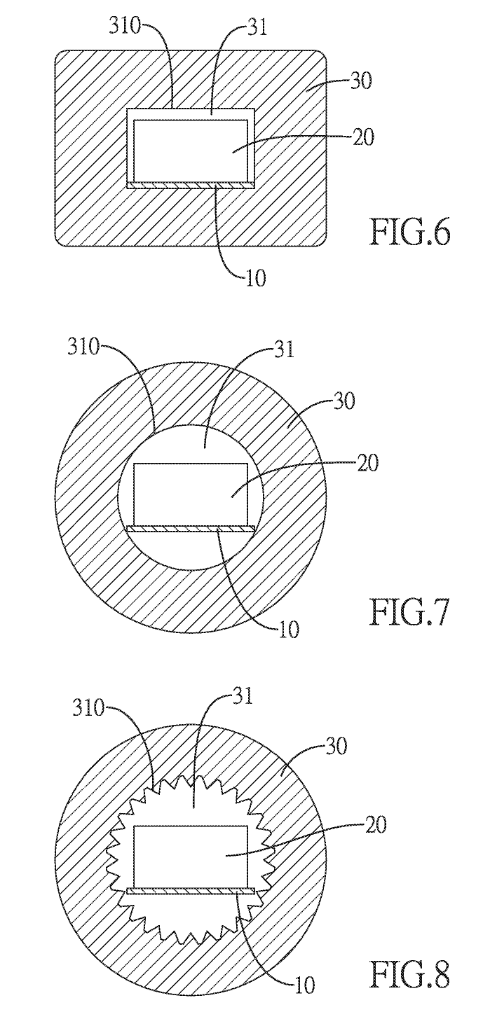

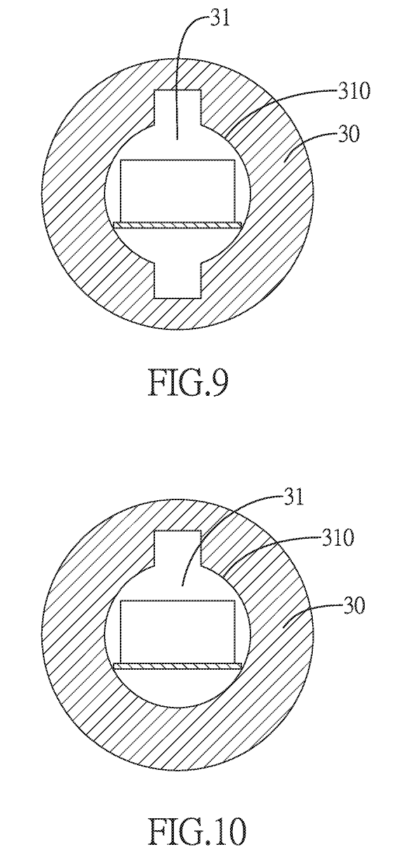

The protection tube 30 can be fabricated to have a rectangular cross-section or a circular cross-section as shown in FIGS. 6 and 7. With reference to FIGS. 6 to 10, the channel 31 has a channel surface 310 fabricated to form different shapes in cross section. For example, the channel surface 310 may have a rectangular cross section shown in FIG. 6, a circular cross section shown in FIG. 7, or keyhole shaped cross sections shown in FIGS. 9 and 10. In FIGS. 9 and 10, at least one groove is formed in the channel surface 310 and communicates with the channel 31, thus forming the keyhole-shaped cross sections. Further, multiple ribs extending along an axis direction of the protection tube 30 may be formed on the channel surface 310 as shown in FIG. 8. Different shapes of the channel surface 310 enable the LED light string to generate a variety of refraction or reflection effects.

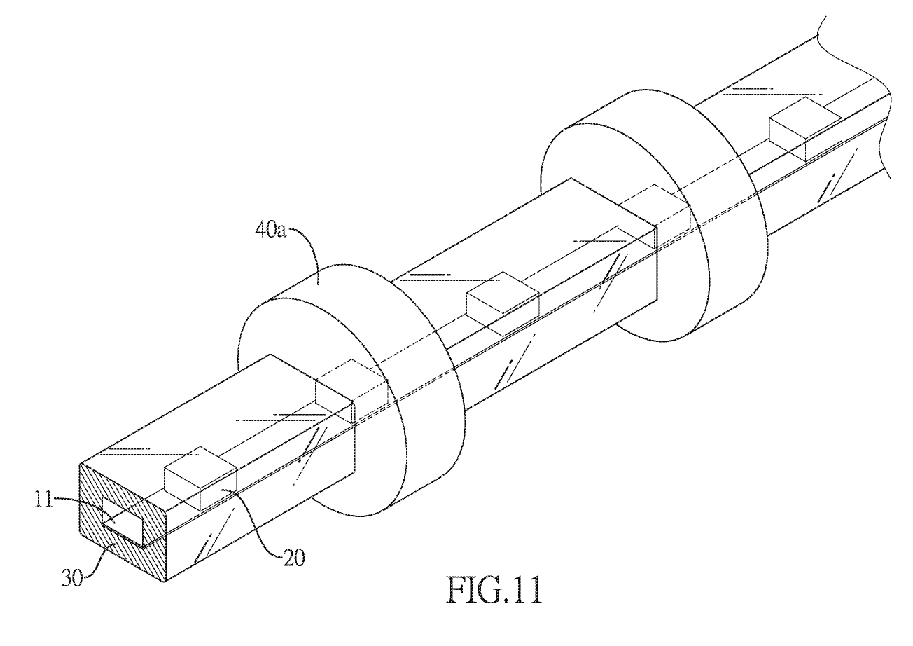

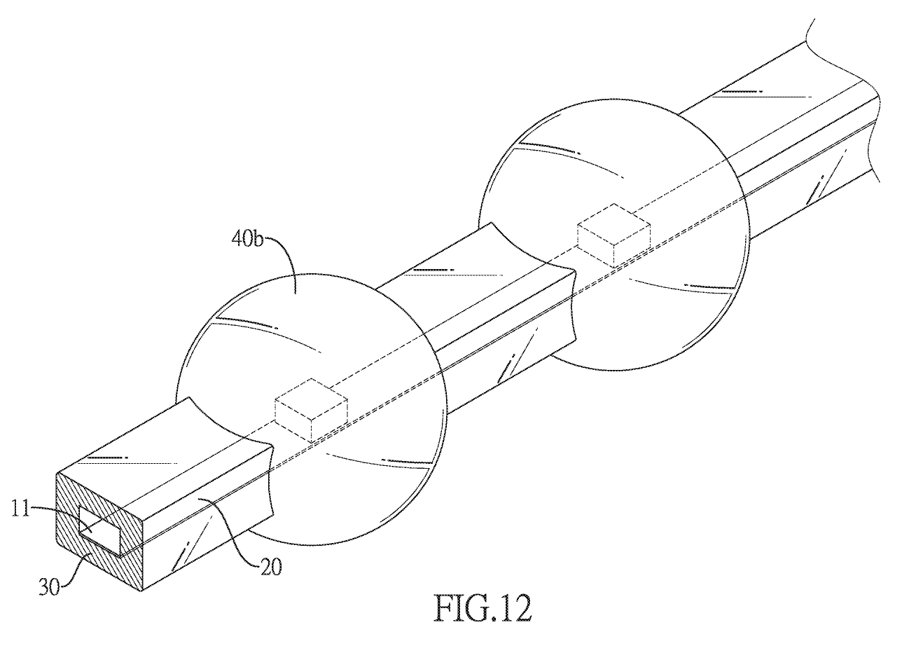

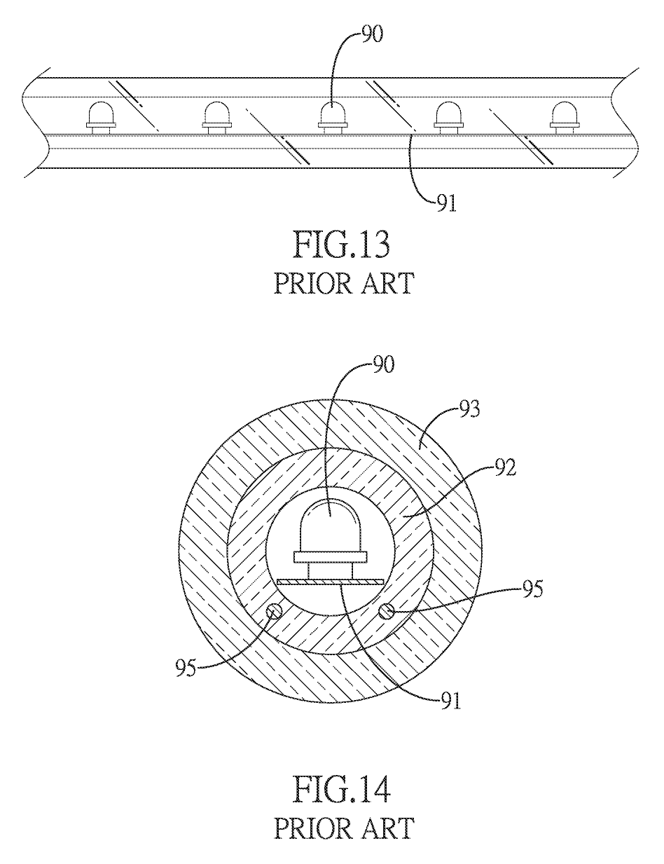

With reference to FIGS. 11 and 12, multiple decorative shells 40a, 40b are further mounted around the protection tube 30 and disposed at positions corresponding to the LEDs 20 to enhance decorative effects. The shapes and colors of the decorative shells 40a, 40b may be varied depending on decoration and illumination purposes. For example, the decorative shells 40a in FIG. 11 are ring-shaped shells alternately disposed around the LEDs 20. In FIG. 12, the decorative shells 40b are hollow ball-shaped shells disposed around the LEDs 20. Other types of decorative shells, such as a Christmas lamp shell, may also be applied on the LED light string. When the LEDs 20 are turned on, light emitted from the LEDs 20 will pass through the decorative shells 40a, 40b and be refracted or reflected by the decorative shells 40a, 40b.

The transparent substrate 11 and the protection tube 30 are sufficiently flexible to enable the LED light string to be rolled or twisted around an object or installed at a position for providing decorative lighting and illumination.

While the transparent substrate 11 is made by clear and transparent material and the LED 20 is packaged by the transparent epoxy filler 26, light generated from the LED 20 can be emitted toward multiple directions to achieve a non-directional lighting effect.

Since the power buses 12, 13 have been formed on the transparent substrate 11, the protection tube 30 does not need power wires embedded therein. Therefore, fabrication process of the protection tube 30 can be simplified.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A light emitting diode (LED) light string for non-directional lighting, comprising:
an LED strip comprising
a transparent substrate being flexible;
multiple conductive wires formed on at least one surface of the transparent substrate, wherein the conducive wires comprise two power buses formed along opposite edges of the transparent substrate and multiple separate intermediate wires formed between the power buses; and
multiple LEDs mounted on the transparent substrate and electrically connected to the intermediate wires and the power buses, wherein each LED is a surface-mounted (SMT) LED and comprises
a base being transparent and having a top surface and a bottom surface;
two leads separate from each other, attached on the top surface of the base, and respectively extending along opposite sides of the base;
a housing being transparent, mounted on the top surface of the base, and forming a cavity;
an LED chip mounted in the cavity and electrically connected to the two leads; and
an epoxy filler being transparent and filling the cavity; and
a protection tube being transparent and flexible and mounted around the LED strip.

2. The LED light string as claimed in claim 1, wherein multiple segment pads are formed on the power buses to divide the transparent substrate to multiple units, the LEDs mounted in the same unit are connected in series, and the multiple units are connected in parallel between the power buses.

3. The LED light string as claimed in claim 1, wherein the protection tube forms a channel for receiving the LED strip, the channel has a channel surface on which multiple ribs extending along an axis direction of the protection tube are formed.

4. The LED light string as claimed in claim 1, wherein the protection tube is a single-layer tube formed by injection molding technique.

5. The LED light string as claimed in claim 3, wherein the channel has a cross section in a keyhole shape.

6. The LED light string as claimed in claim 5, wherein at least one groove is formed on the channel surface and communicates with the channel.

7. The LED light string as claimed in claim 1, wherein multiple decorative shells are mounted around the protection tube at positions respectively corresponding to the LEDs.

8. The LED light string as claimed in claim 7, wherein each of the decorative shells is a ring-shaped shell.

9. The LED light string as claimed in claim 7, wherein each of the decorative shells is a ball-shaped shell.
